(19) United States
(12) Patent Application Publication
(10) Pub. No.: US 2008/0049254 A1
(43) Pub. Date: Feb. 28, 2008

(54) METHOD AND MEANS FOR CO-SCHEDULING JOB ASSIGNMENTS AND DATA REPLICATION IN WIDE-AREA DISTRIBUTED SYSTEMS

(76) Inventors: Thomas Phan, San Jose, CA (US); Kavitha Ranganathan, New York, NY (US); Radu Sion, Sound Beach, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/466,778

(22) Filed: Aug. 24, 2006

(51) Int. Cl. G06K 15/00

(52) U.S. Cl. 358/1.16

(57) ABSTRACT

The embodiments of the invention provide a method, service, computer program product, etc. of co-scheduling job assignments and data replication in wide-area systems using a genetic method. A method begins by co-scheduling assignment of jobs and replication of data objects based on job ordering within a scheduler queue, job-to-compute node assignments, and object-to-local data store assignments. More specifically, the job ordering is determined according to an order in which the jobs are assigned from the scheduler to the compute nodes. Further, the job-to-compute node assignments are determined according to which of the jobs are assigned to which of the compute nodes; and, the object-to-local data store assignments are determined according to which of the data objects are replicated to which of the local data stores.

### BACKGROUND

1. Field of the Invention

The embodiments of the invention provide a method, service, computer program product, etc. of co-scheduling job assignments and data replication in wide-area systems using a genetic method.

2. Description of the Related Art

Within this application several publications are referenced by arabic numerals within brackets. Full citations for these, and other, publications may be found at the end of the specification immediately preceding the claims. The disclosures of all these publications in their entireties are hereby expressly incorporated by reference into the present application for the purposes of indicating the background of the present invention and illustrating the state of the art.

Traditional job schedulers for grid or cluster systems are responsible for assigning incoming jobs to compute nodes in such a way that some evaluative condition is met, such as the minimization of the overall execution time of the jobs or the maximization of throughput or utilization. Such systems generally take into consideration the availability of compute cycles, task queue lengths, and expected job execution times, but they typically do not account directly for data staging and thus miss significant associated opportunities for optimization. Indeed, the impact of data and replication management on job scheduling behavior has largely remained unstudied. Embodiments herein simultaneously schedule both job assignments and data replication and provide an optimized co-scheduling method as a solution.

This problem is especially relevant in data-intensive grid and cluster systems where increasingly fast networks connect vast numbers of computation and storage resources. For example, the Grid Physics Network [Griphyn] and the Particle Physics Data Grid [PPDG] require access to massive (in the scale of petabytes) amounts of data files for computational jobs. In addition to traditional files, more diverse and widespread utilization of other types of data from a variety of sources are anticipated; for example, grid applications may use Java objects from an RMI server, SOAP replies from Web service, or aggregated SQL tuples from a DBMS.

Given that large-scale data access is an increasingly important part of grid applications, an intelligent job-dispatching scheduler should be aware of data transfer costs because jobs should have their requisite data sets in order to execute. In the absence of such awareness, data is manually staged at compute nodes before jobs can be started (thereby inconveniencing the user) or replicated and transferred by the system but with the data costs neglected by the scheduler (thereby producing sub-optimal and inefficient schedules). Thus, a tighter integration of job scheduling and automated data replication potentially yields significant advantages due to the potential for optimized, faster access to data and decreased overall execution time. However, there are significant challenges to such an integration, including the minimization of data transfers costs, the placement scheduling of jobs to compute nodes with respect to the data costs, and the performance of the scheduling method itself. Overcoming these obstacles involves creating an optimized schedule that minimizes the submitted jobs' time to completion (the “makespan”) that should take into consideration both computation and data transfer times.

Previous efforts in job scheduling either do not consider data placement at all or often feature “last minute” sub-optimal approaches, in effect decoupling data replication from job dispatching. Traditional FIFO (first-in-first-out) and backfilling parallel schedulers (surveyed in [Feitelson95] and [Feitelson+04]) assume that data is already pre-staged and available to the application executables on the compute nodes, while workflow schedulers consider only the precedence relationship between the applications and the data and do not consider optimization, e.g [Kosar+04]. Other recent approaches for co-scheduling provide greedy, sub-optimal solutions, e.g. [Casanova+00] [Ranganathan+03] [Mohamed+04].

The need for scheduling job assignment and data placement together arises from modern clustered deployments. The work in [Thain+01] suggests I/O (input/output) communities can be formed from compute nodes clustered around a storage system. Other researchers have looked at the high-level problem of precedence workflow scheduling to ensure that data has been automatically staged at a compute node before assigned jobs at that node being computing [Deelman+04] [Kosar+04]. Such work assumes that once a workflow schedule has been planned, lower-level batch schedulers will execute the proper job assignments and data replication. Embodiments of the invention fit into this latter category of job and data schedulers.

Other researchers have also looked into the problem of job and data co-scheduling, but none have considered an integrated approach or optimization methods to improve scheduling performance. The XSufferage method [Casanova+00] includes network transmission delay during the scheduling of jobs to sites, but only replicates data from the original source repository and not across sites. The work in [Ranganathan+03] looks at a variety of techniques to intelligently replicate data across sites and assign jobs to sites; the best results come from a scheme where local monitors keep track of popular files and preemptively replicate them to other sites, thereby allowing a scheduler to assign jobs to those sites that already host needed data. However, embodiments herein consider jobs that use a single input file and assumes homogeneous network conditions. The Close-to-Files method [Mohamed+04] assumes that single-file input data has already been replicated across sites and then uses an exhaustive method to search across all combinations of compute sites and data sites to find the combination with the minimum cost, including computation and transmission delay. The Storage Affinity method [Santos-Neto+04] treats file systems at each site as a passive cache; an initial job executing at a site must pull in data to the site, and subsequent jobs are assigned to sites that have the most amount of needed residual data from previous application runs. The work in [Chakrabarti+04] decouples jobs scheduling from data scheduling: at the end of periodic intervals when jobs are scheduled, the popularity of needed files is calculated and then used by the data scheduler to replicate data for the next set of jobs, which may or may not share the same data requirements as the previous set.

Although these previous efforts have identified and addressed the problem of job and data co-scheduling, the scheduling is generally based on decoupled methods that schedule jobs in reaction to prior data scheduling. Furthermore, all these previous methods perform FIFO scheduling for only one job at a time, resulting in typically locally-optimum schedules only. None have addressed the co-scheduling problem in an integrated manner that considers both aspects of job and data placement simultaneously. Embodiments herein execute a genetic method that converges to a (near) optimal schedule by looking at the jobs in the scheduler queue as well as replicated data objects at once. This genetic approach allows the best combination of three variables to be found: job ordering in the queue, job assignments to compute nodes, and data replication to local data stores. While other researchers have looked at global optimization methods for job scheduling [Braun+01] [Schmueli+03], they do not consider job and data co-scheduling.

In summary, although other research efforts have looked into the issue of job scheduling and data replication, embodiments herein provide a methodology to provide simultaneous co-scheduling in an integrated manner and with near-optimal performance using global optimization heuristics.

### SUMMARY

The embodiments of the invention provide a method, service, computer program product, etc. of co-scheduling job assignments and data replication in wide-area systems using a genetic method. A method begins by co-scheduling assignment of jobs and replication of data objects based on job ordering within a scheduler queue, job-to-compute node assignments, and object-to-local data store assignments. More specifically, the job ordering is determined according to an order in which the jobs are assigned from the scheduler to the compute nodes. Further, the job-to-compute node assignments are determined according to which of the jobs are assigned to which of the compute nodes; and, the object-to-local data store assignments are determined according to which of the data objects are replicated to which of the local data stores.

The embodiment of this co-scheduling includes creating chromosomes having first strings, second strings, and third strings in the following manner:the first strings include possible arrays of the job ordering; the second strings include possible arrays of the job-to-compute node assignments; and the third strings include possible arrays of the object-to-local data store assignments. Next, the first strings, the second strings, and the third strings can be recombined and/or mutated to create new arrays of job ordering, job-to-compute node assignments, and object-to-local data store assignments. Subsequently, the first strings, second strings, and third strings are evaluated to determine an estimation of the completion time for executing the job scheduling and data placement. Multiple generations of the recombination and/or mutation and the subsequent evaluation are performed; the first string, second string, and third string that produced the best completion time is selected. Following this, the jobs are assigned to the compute nodes based on results of the co-scheduling; and, the data objects are simultaneously replicated to the local data stores based the results of the co-scheduling.

Accordingly, the embodiments of the invention include the following. First, co-scheduling of job dispatching and data replication assignments and simultaneously scheduling both for achieving good makespans is identified. Second, it is shown that deploying a genetic search method to solve the optimal allocation problem has the potential to achieve significant speed-up results versus traditional allocation mechanisms. Embodiments herein provide three variables within a job scheduling system, namely the order ofjobs in the scheduler queue, the assignment of jobs to compute nodes, and the assignment of data replicas to local data stores. There exists an optimal solution that provides the best schedule with the minimal makespan, but the solution space is prohibitively large for exhaustive searches. To find the optimal (or near-optimal) combination of these three variables in the solution space, an optimization heuristic is provided using a genetic method. By representing the three variables in a “chromosome” and allowing them to compete and evolve, the method converges towards an optimal (or near-optimal) solution.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a diagram illustrating a job submission system in a generalized distribution grid;

FIG. 2 illustrates pseudocode for a genetic search method;

FIG. 3A illustrates a job ordering chromosome;

FIG. 3B illustrates a job-to-compute node chromosome;

FIG. 3C illustrates an object-to-local data store chromosome;

FIG. 4 illustrates several lookup tables;

FIG. 5 illustrates pseudocode for a genetic method evaluation function;

FIG. 6 is a flow diagram illustrating a method of co-scheduling job assignments and data replication in wide-area systems using a genetic method; and

FIG. 7 is a diagram of a computer program product of co-scheduling job assignments and data replication in wide-area systems using a genetic method.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

The embodiments of the invention include the following. First, co-scheduling of job dispatching and data replication assignments and simultaneously scheduling both for achieving good makespans is identified. Second, it is shown that deploying a genetic search method to solve the optimal allocation problem has the potential to achieve significant speed-up results versus traditional allocation mechanisms. Embodiments herein provide three variables within a job scheduling system, namely the order of jobs in the scheduler queue, the assignment of jobs to compute nodes, and the assignment of data replicas to local data stores. There exists an optimal solution that provides the best schedule with the minimal makespan, but the solution space is prohibitively large for exhaustive searches. To find the optimal (or near-optimal) combination of these three variables in the solution space, an optimization heuristic is provided using a genetic method. By representing the three variables in a “chromosome” and allowing them to compete and evolve, the method converges towards an optimal (or near-optimal) solution.

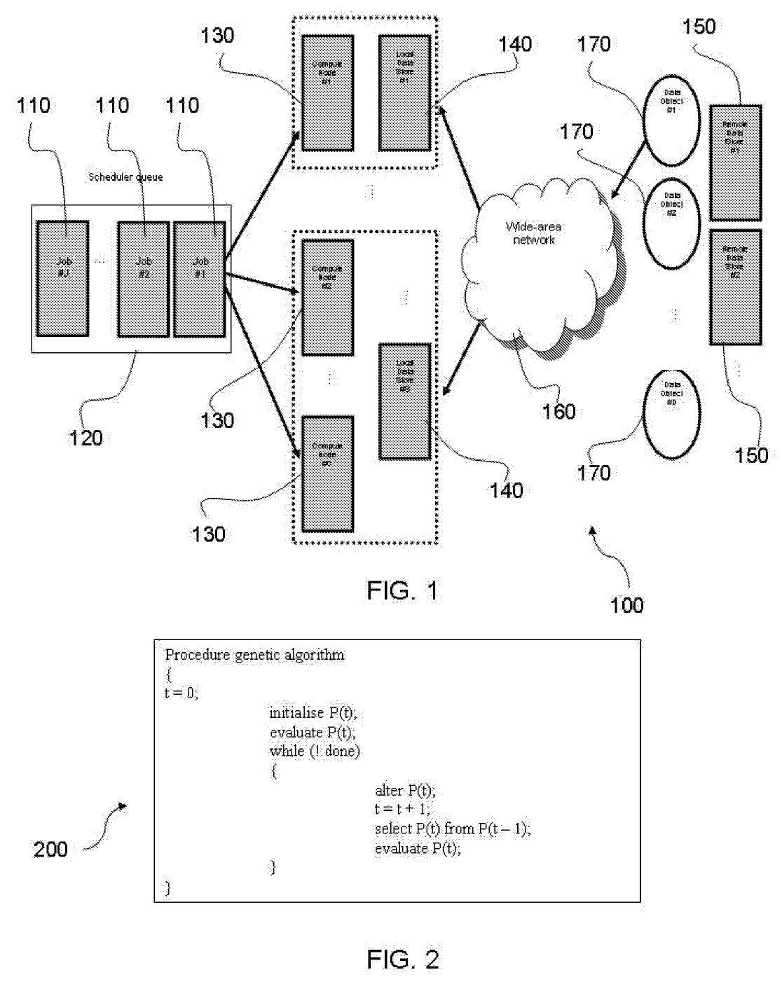

A job and data co-scheduling model 100 is illustrated in FIG. 1, wherein a high-level overview of a job submission system in a generalized distribution grid is provided. The scenario depicts a typical distributed grid or cluster deployment. Jobs 110 are submitted to a centralized scheduler 120 that queues the jobs 110 until they are dispatched to distributed compute nodes 130. The scheduler 120 can potentially be a meta-scheduler that assigns jobs 110 to other local schedulers (to improve scalability at the cost of increased administration), but in FIG. 1 only a single centralised scheduler 120 responsible for assigning jobs 110 is considered.

The compute nodes 130 are supported by local data stores 140 capable of caching read-only replicas of data downloaded from remote data stores 150. The local data stores 140, depending on the context of the applications, can range from web proxy caches to data warehouses. It is assumed that the compute nodes 130 and the local data stores 140 are connected on a high-speed LAN (e.g. Ethernet or Myrinet) and that data can be transferred across the stores. The model 100 can be extended to multiple LANs containing clusters of compute nodes and data stores, but for simplicity a single LAN is assumed. Data downloaded from the remote store 140 crosses a wide-area network 160 such as the Internet. The terms “data object”, “object”, “data object 170”, or “object 170” [Stockinger+01] are used to encompass a variety of potential data manifestations, including Java objects and aggregated SQL tuples, although its meaning can be construed to be a file on a file system.

The model 100 includes the following assumptions. First, the jobs 110 follow the bag-of-tasks programming model with no inter-job communication. Second, data retrieved from the remote data stores 150 is read-only. Output being written back to the remote data stores 150 is not considered because computed output is typically directed to the local file system at the compute nodes 130 and such output is commonly much smaller and negligible compared to input data. Further, the computation time required by a job 110 is known to the scheduler 120. In practical terms, when jobs 110 are submitted to the scheduler 120, the submitting user typically assigns an expected duration of usage to each job 110 [Mu'alem+01]. Moreover, the data objects 170 required to be downloaded for a job 110 are known to the scheduler 120 and can be specified at the time of job submission. Additionally, the communication cost for acquiring the data objects 170 can be calculated for each job 110. The only communication cost considered is transmission delay, which can be computed by dividing a data object 170's size by the bottleneck bandwidth between a sender and receiver. As such, queueing delay or propagation delay is not considered. Furthermore, if the data object 170 is a file, its size is typically known to the job 110's user and specified at submission time. On the other hand, if the data object 170 is produced dynamically by a remote server, it is assumed that there exists a remote API that can provide the approximate size of the data object 170. For example, for data downloads from a web server, a HTTP's HEAD method can be used to get the requested URI's (uniform resource identifier's) size prior to actually downloading it. Moreover, the bottleneck bandwidth between two network points can be ascertained using known techniques [Hu+04] [Ribeiro+04] that typically trade off accuracy with convergence speed. It is assumed that such information can be periodically updated by a background process and made available to the scheduler 120. In addition, arbitrarily detailed delays and costs are not included in the model 100 (e.g., database access time, data marshalling, or disk rotational latency), as these are dominated by transmission delay and computation time.

Given such assumptions, the lifecycle of a submitted job 110 proceeds as follows. When a job 110 is submitted to the queue, the scheduler 120 assigns it to a compute node 130 (using a traditional load-balancing method or the method discussed herein). Each compute node 130 maintains its own queue from which jobs 110 run in FIFO order. Each job 110 requires data objects 170 from remote data stores 150; these data objects 170 can be downloaded and replicated to one of the local data stores 140 (again, using a traditional method or the method discussed herein), thereby obviating the need for subsequent jobs 110 to download the same data objects 170 from the remote data store 150. All required data objects 170 are downloaded before a job 110 can begin, and data objects 170 are downloaded on-demand in parallel at the time that a job 110 is run. Although parallel downloads will almost certainly reduce the last hop's bandwidth, for simplicity it is assumed that the bottleneck bandwidth is a more significant concern. A requested data object 170 will be downloaded from a local data store 140, if it exists there, rather than from the remote store 150. If a job 110 requires a data object 170 that is currently being downloaded by another job 110 executing at a different compute node 130, the job 110 either waits for that download to complete or instantiates its own, whichever is faster based on expected download time maintained by the scheduler 120.

Thus, it can be seen that if jobs 110 are assigned to compute nodes 130 first, the latency required to access data objects 170 may vary drastically because the objects 170 may or may not have been already cached at a close local data store 140. On the other hand, if data objects 170 are replicated to local data stores 140 first, then the subsequent job executions will be delayed due to these same variations in access costs. Furthermore, the ordering of the jobs 110 in the queue can affect the performance. For example, if job 110A is waiting for job 110B (on a different compute node 130) to finish downloading an object 170, job 110A blocks any other jobs 110 from executing on its compute node 130. Instead, if the job queue is rearranged such that other shorter jobs 110 run before job 110A, then these shorter jobs 110 can start and finish by the time job 110A is ready to run. This approach is similar to backfilling methods [Lifka95] that schedule parallel jobs requiring multiple processors. The resulting tradeoffs affect the makespan.

With this scenario as it is illustrated in FIG. 1, it can be seen that there are three independent variables in the system, namely (1) the ordering of the jobs 110 in the scheduler 120's queue, which translates to the ordering in the individual queue at each compute node 130; (2) the assignment of jobs 110 in the queue to the compute nodes 130; and, (3) the assignment of the data object 170 replicas to the local data stores 140. The number of combinations can be determined as follows: suppose there are J jobs 110 in the scheduler 120 queue. There are then J! ways to arrange the jobs 110. Suppose there are C compute nodes 130. There are then C^{J} ways to assign the J jobs 110 to these C compute nodes 130. Suppose there are D data objects 170 and S local data stores 140. There are then S^{D} ways to replicate the D objects 170 onto the S stores 140. There are thus J! C^{J}·S^{D} different combinations of these three assignments. Within this solution space there exists some tuple of {job ordering, job-to-compute node assignment, and object-to-local data store assignment} that will produce the minimal makespan for the set ofjobs 110. However, for any reasonable deployment instantiation (e.g., J=20 and C=10), the number of combinations becomes prohibitively large for an exhaustive search.

Existing work in job scheduling can be analyzed in the context presented above. Prior work in schedulers that dispatch jobs in FIFO order eliminate all but one of the J! job orderings possible. Schedulers that also assume the data objects have been preemptively assigned to local data stores eliminate all but one of the S^{D} ways to replicate. Essentially all prior efforts have made assumptions that allow the scheduler to make decisions from a drastically reduced solution space that may or may not include the optimal schedule.

The relationship between these three variables is intertwined. Although they can be changed independently of one another, adjusting one variable will have an adverse or beneficial effect on the schedule's makespan that can be counter-balanced by adjusting another variable.

With a solution space size of J!·C^{J}·S^{D}, a goal is to find the schedule in this space that produces the shortest makespan. To achieve this goal, a genetic method [Baeck+00] is used as a search heuristic. While other approaches exist, each has its limitations. For example, an exhaustive search, as mentioned, would be pointless given the potentially huge size of the solution space. An iterated hill-climbing search samples local regions but may get stuck at a local optima. Simulated annealing can break out of local optima, but the mapping of this approach's parameters, such as the temperature, to a given problem domain is not always clear.

A genetic method (GM) simulates the behavior of Darwinian natural selection and converges upon an optimal (or near-optimal) solution through successive generations of recombination, mutation, and selection, as shown in the pseudocode 200 of FIG. 2 (adapted from [Michalewicz+00]). A potential solution in the problem space is represented as a chromosome, as more fully described below. In the context of this problem, one chromosome is a schedule that consists of string representations of a tuple of {queue order, job assignments, object assignments}.

Initially, a random set of chromosomes is instantiated as the population. The chromosomes in the population are evaluated (hashed) to some metric, and the best ones are chosen to be parents. In this context, the evaluation produces the makespan that results from executing the schedule of a particular chromosome. The parents recombine to produce children (simulating sexual crossover), and occasionally a mutation may arise which produces new characteristics that were not present in either parent; for simplification, embodiments herein did not implement the optional mutation. The best subset of the children is chosen (based on an evaluation function) to be the parents of the next generation. Elitism is further implemented, where the best chromosome is guaranteed to be included in each generation in order to accelerate the convergence to the global optimum (if it is found). The generational loop ends when some criteria is met (e.g., termination after 100 generations). At the end, a global optimum or near-optimum can be found. Note that finding the global optimum is not guaranteed because the recombination has probabilistic characteristics.

Using a genetic method is suited in this context. The job queue, job assignments, and object assignments can be represented as character strings, which allows the leverage of prior genetic method research in how to effectively recombine string representations of chromosomes [Davis85]. Additionally, a genetic method's running time can be traded off for increased accuracy: increasing the running time of the method increases the chance that the optimal solution can be found. While this is true of all search heuristics, a genetic method has the potential to converge to an optimum very quickly.

An objective of the genetic method is to find a combination of the three variables that minimizes the makespan for the jobs. The resulting schedule that corresponds to the minimum makespan will be carried out, with jobs being executed on compute nodes and data objects being replicated to data stores in order to be accessed by the executing jobs. At a high level, the workflow proceeds as follows. First, jobs are queued. Jobs requests enter the system and are queued by the job scheduler.

Next, the scheduler takes a snapshot of the jobs in the queue. In order to achieve the tightest packing of jobs into a schedule, the scheduling method should look at a large window of jobs at once. FIFO schedulers consider only the front job in the queue. The optimizing scheduler in [Shmueli+03] uses dynamic programming and considers a large group of jobs, which they call “lookahead,” on the order of 10-50 jobs. Embodiments herein call the collection of jobs a snapshot window. The scheduler takes this snapshot of queued jobs and feeds it into the scheduling method. Taking the snapshot can vary in two ways, namely by the frequency of taking the snapshot (e.g., at periodic wallclock intervals or when a particular queue size is reached) or by the size of the snapshot window (e.g., the entire queue or a portion of the queue starting from the front). Embodiments herein can consider the entire queue at once.

Following this, the GM converges to the optimal schedule. Given a snapshot, the genetic method executes. An objective of the method is to find the minimal makespan. The evaluation function, as more fully described below, takes the current instance of the three variables as input and returns the resulting makespan. As the genetic method executes, it can converge to an optimal (or near-optimal) schedule with the minimum makespan.

Next, the schedule is executed. Given the genetic method's output of an optimal schedule consisting of the job order, job assignments, and object assignments, the schedule is executed. Jobs are executed on the compute nodes, and the data objects are replicated on-demand to the data stores so they can be accessed by the jobs.

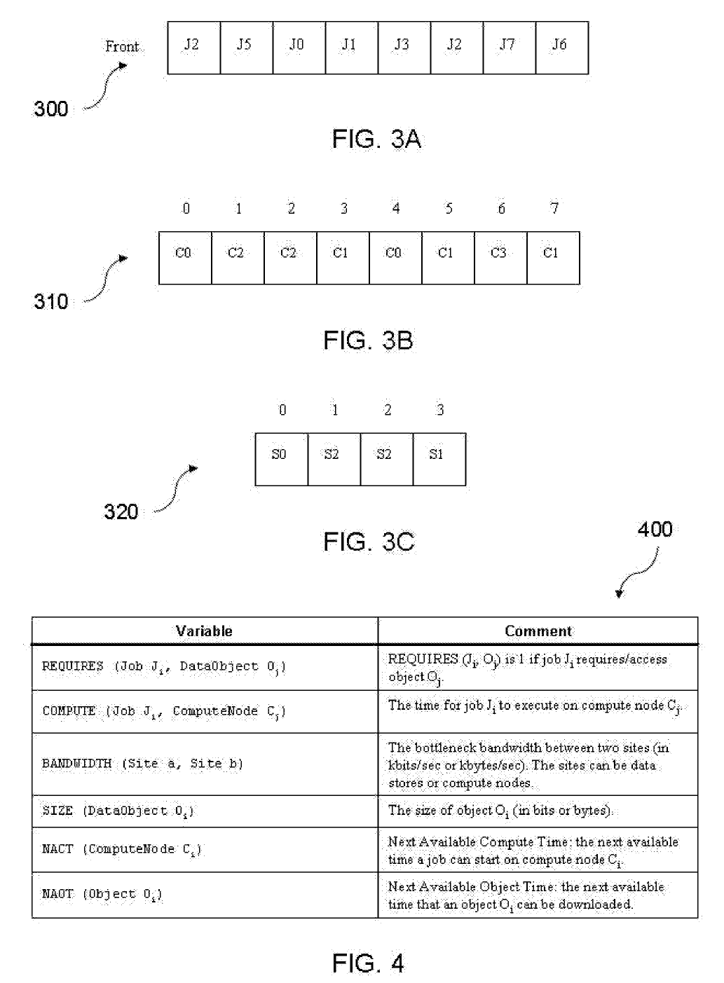

Each chromosome consists of three strings, corresponding to the job ordering, the assignment of jobs to compute nodes, and the assignment of data objects to local data stores. As illustrated in FIGS. 3A-3C, each one can be represented as an array of integers. For each type of chromosome, recombination and mutation can only occur between strings representing the same characteristic.

FIG. 3A illustrates a job ordering chromosome 300 having a queue of 8 jobs. The job ordering for a particular snapshot window can be represented as a queue (vector) of job identifiers. the jobs can have their own range of identifiers, but once they are in the queue, they can be represented by a simpler range of identifiers going from job 0 to J-1 for a snapshot of J jobs. The representation is a vector of these identifiers.

FIG. 3B illustrates an assignment of jobs to compute nodes chromosome 310 having 8 jobs which can be mapped to 4 compute nodes. The assignments can be represented as an array of size J, and each cell in the array takes on value between 0 and C-1 for C compute nodes. The i^{th} element of the array contains an integer identifier of the compute node to which job i has been assigned.

FIG. 3C illustrates an assignment of data object replicas to local data store chromosome 320 having 4 data objects which can be replicated onto 3 local data. Similarly, these assignments can be represented as an array of size D for D number of objects, and each cell can take on a value between 0 and S-1 for S local data stores. The i^{th} element contains an integer identifier of the local data store to which object i has been assigned.

Recombination is applied only to strings of the same type to produce a new child chromosome. In a two-parent recombination scheme for arrays of unique elements, a 2-point crossover scheme can be used where a contiguous subsection of the first parent is copied to the child, and then all remaining items in the second parent (that have not already been taken from the first parent's subsection) are then copied to the child in order [Davis85].

In a uni-parent mutation scheme, two items can be chosen at random from an array and the elements can be reversed between them, inclusive. Mutation can be used to increase the probability of finding global optima. Other recombination and mutation schemes are also possible, as well as different chromosome representations.

A component of the genetic method is the evaluation function. Given a particular job ordering, set of job assignments to compute nodes, and set of object assignments to local data stores, the evaluation function returns the makespan. The makespan is calculated deterministically from the method described below. The rules use the lookup table 400 in FIG. 4. The evaluation function is replaceable: if a different model of job execution is used (with different ways of managing object downloads and executing jobs), a different evaluation function could be plugged into the GM. The same evaluation is executed for all the chromosomes in the population.

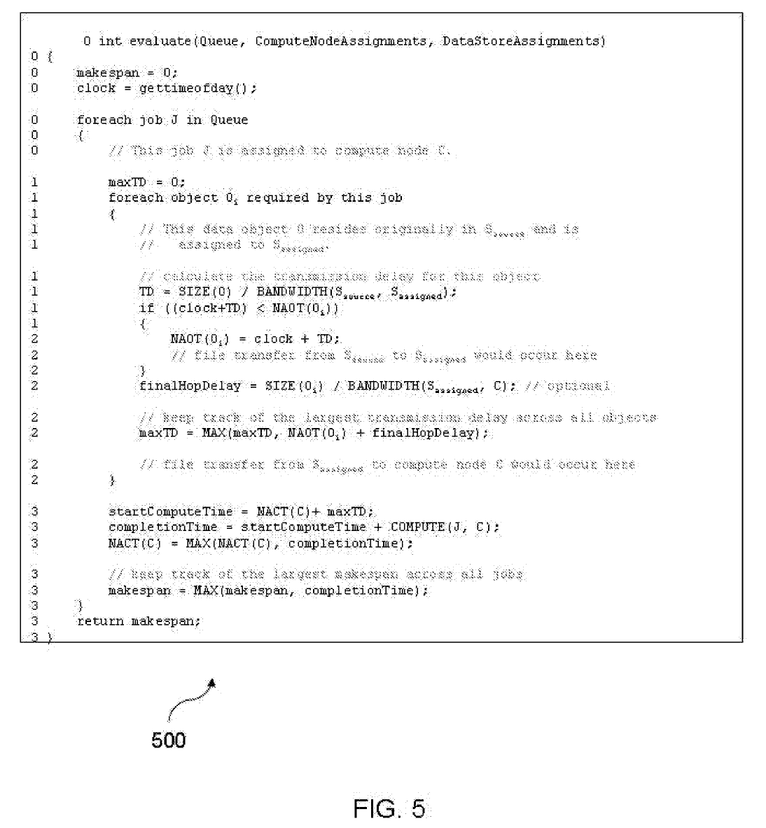

At any given iteration of the genetic method, the evaluation function executes to find the makespan of the jobs in the current queue snapshot. The pseudocode 500 of the evaluation function is shown in FIG. 5. The evaluation function considers all jobs in the queue over the loop spanning lines 6 to 37. As part of the randomization performed by the genetic method at a given iteration, the order of the jobs in the queue will be set, allowing the jobs to be dispatched in that order.

In the loop spanning lines 11 to 29, the function looks at all objects required by the currently considered job and finds the maximum transmission delay incurred by the objects. Data objects required by the job are downloaded to the compute node prior to the job's execution either from the data object's source data store or from a local data store. Since the assignment of data object to local data store is known during a given iteration of the genetic method, the transmission delay of moving the object from the source data store to the assigned local data store can be calculated (line 17) and then update the NAOT (next available object time) table entry corresponding to this data object (lines 18-22). The NAOT is the next available time that the object is available for a final-hop transfer to the compute node regardless of the local data store. The object may have already been transferred to a different data store, but if the current job can transfer it faster to its assigned data store, then it will do so (lines 18-22). Also, if the object is assigned to a local data store that is on the compute nodes' LAN, then the object is still be transferred across one more hop to the compute node (see line 23 and 26).

Lines 31 and 32 compute the start and end computation time for the job at the compute node. Line 36 keeps track of the largest completion time seen so far for all the jobs. Line 38 returns the resulting makespan, i.e. the longest completion time for the current set of jobs.

Accordingly, the embodiments of the invention provide a method, service, computer program product, etc. of co-scheduling job assignments and data replication in wide-area systems using a genetic method. A method begins by co-scheduling assignment of jobs and replication of data objects based on job ordering within a scheduler queue, job-to-compute node assignments, and object-to-local data store assignments. As discussed above, FIG. 1 illustrates that the job ordering, the job-to-compute node assignments, and the object-to-local data store assignments are three independent variables that affect the optimal allocation of job assignments and data replication that has the potential to achieve significant speed-up results versus traditional allocation mechanisms.

More specifically, the job ordering is determined according to an order in which the jobs are assigned from the scheduler to the compute nodes; and, the job-to-compute node assignments are determined according to which of the jobs are assigned to which of the compute nodes. As discussed above, when a job is submitted to the queue, the scheduler assigns it to a compute node. Each compute node maintains its own queue from which jobs run in first-in-first-out order.

The object-to-local data store assignments are determined according to which of the data objects are replicated to which of the local data stores. As discussed above, each job requires data objects from remote data stores; these objects can be downloaded and replicated to one of the local data stores (again, using a traditional method or the method we discuss in this paper), thereby obviating the need for subsequent jobs to download the same objects from the remote data store. All required data must be downloaded before a job can begin, and objects are downloaded on-demand in parallel at the time that a job is run.

Furthermore, the co-scheduling includes creating chromosomes having first strings, second strings, and third strings, such that the first strings include possible arrays of the job ordering. Moreover, the second strings include possible arrays of the job-to-compute node assignments; and, the third strings include possible arrays of the object-to-local data store assignments. As discussed above, a random set of chromosomes is initially instantiated as the population. The chromosomes in the population are evaluated (hashed) to some metric, and the best ones are chosen to be parents. The evaluation produces the makespan that results from executing the schedule of a particular chromosome.

Next, the first strings, the second strings, and the third strings can be recombined and/or mutated to create new arrays of job ordering, job-to-compute node assignments, and object-to-local data store assignments. As more fully described above, by representing the job ordering, the job-to-compute node assignments, and the object-to-local data store assignments in a “chromosome” and allowing them to compete and evolve, the method naturally converges towards an optimal (or near-optimal) solution.

Additionally, the co-scheduling includes determining an execution time of one or more of the new arrays. As discussed above, given a particular job ordering, set of job assignments to compute nodes, and set of object assignments to local data stores, the evaluation function returns the makespan. Following this, the jobs are assigned to the compute nodes based on results of the co-scheduling; and, the data objects are simultaneously replicated to the local data stores based the results of the co-scheduling.

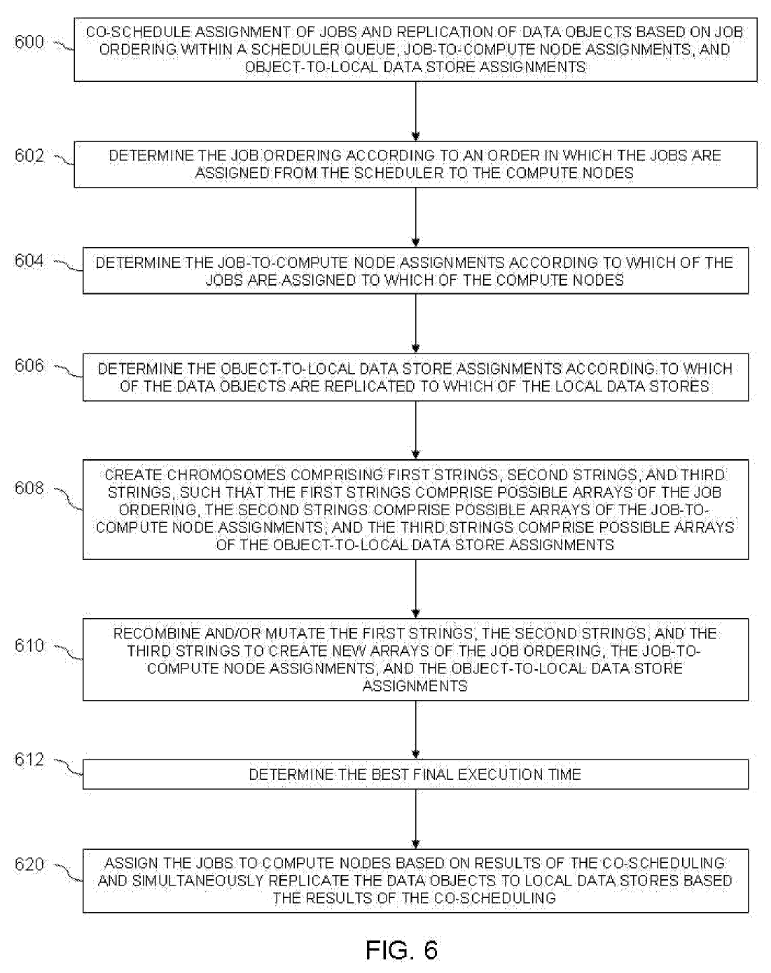

FIG. 6 illustrates a flow diagram of a method of co-scheduling job assignments and data replication in wide-area systems using a genetic method. In item 600, the method begins by co-scheduling an assignment of jobs and a replication of data objects based on job ordering within a scheduler queue, job-to-compute node assignments, and object-to-local data store assignments. As discussed above, FIG. 1 illustrates that the job ordering, the job-to-compute node assignments, and the object-to-local data store assignments are three independent variables that will produce the minimal makespan for the set ofjobs.

More specifically, the job ordering is determined according to an order in which the jobs are assigned from the scheduler to the compute nodes (item 602); and, the job-to-compute node assignments are determined according to which of the jobs are assigned to which of the compute nodes (item 604). As discussed above, when a job is submitted to the queue, the scheduler assigns it to a compute node. Each compute node maintains its own queue from which jobs run in first-in-first-out order.

The object-to-local data store assignments are determined according to which of the data objects are replicated to which of the local data stores (item 606). As discussed above, each job requires data objects from remote data stores; these objects can be downloaded and replicated to one of the local data stores (again, using a traditional method or the method we discuss in this paper), thereby obviating the need for subsequent jobs to download the same objects from the remote data store. A requested object will be downloaded from a local data store, if it exists there, rather than from the remote store. If a job requires an object that is currently being downloaded by another job executing at a different compute node, the job either waits for that download to complete or instantiates its own, whichever is faster based on expected download time maintained by the scheduler.

Furthermore, in item 608, the co-scheduling includes creating chromosomes having first strings, second strings, and third strings, such that the first strings include possible arrays of the job ordering. Moreover, the second strings include possible arrays of the job-to-compute node assignments; and, the third strings include possible arrays of the object-to-local data store assignments. As discussed above, a random set of chromosomes is initially instantiated as the population. The chromosomes in the population are evaluated (hashed) to some metric, and the best ones are chosen to be parents. The evaluation produces the makespan that results from executing the schedule of a particular chromosome.

Next, in item 610, the first strings, the second strings, and the third strings can be recombined and/or mutated to create new arrays of job ordering, job-to-compute node assignments, and object-to-local data store assignments. As more fully described above, the genetic method simulates the behavior of Darwinian natural selection and converges upon an optimal (or near-optimal) solution through successive generations of recombination, mutation, and selection, as shown in the pseudocode of FIG. 2.

Additionally, in item 612, the co-scheduling includes determining an execution time of one or more of the new arrays (i.e., the best final execution time). As discussed above, given a particular job ordering, set of job assignments to compute nodes, and set of object assignments to local data stores, the evaluation function returns the makespan. Following this, in item 620, the jobs are assigned to the compute nodes based on results of the co-scheduling; and, the data objects are simultaneously replicated to the local data stores based the results of the co-scheduling.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

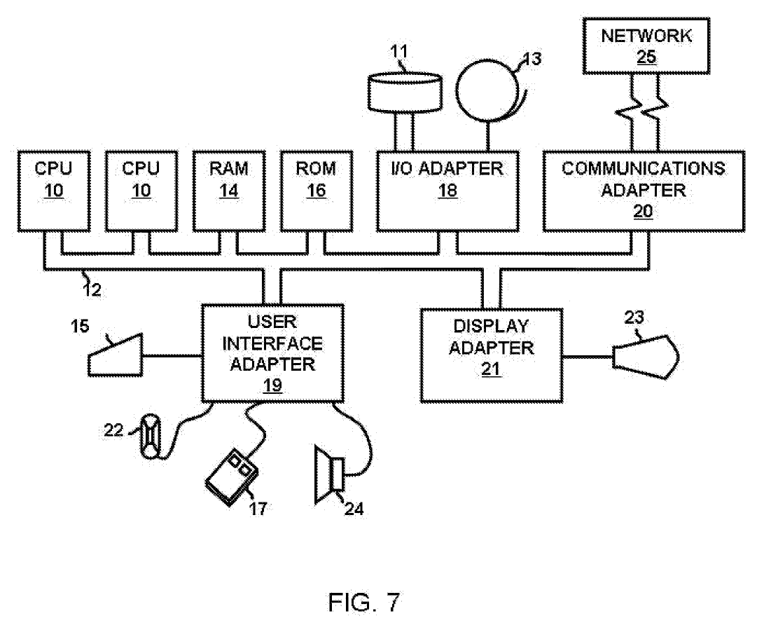

A representative hardware environment for practicing the embodiments of the invention is depicted in FIG. 7. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The embodiments of the invention include the following. First, co-scheduling of job dispatching and data replication assignments and simultaneously scheduling both for achieving good makespans is identified in the domain of wide-area distributed systems. Second, it is shown that deploying a genetic search method to solve the optimal allocation problem has the potential to achieve significantly better results versus traditional allocation mechanisms. Embodiments herein provide three variables within a job scheduling system, namely the order of jobs in the scheduler queue, the assignment of jobs to compute nodes, and the assignment of data replicas to local data stores. There exists anoptimal solution that provides the best schedule with the minimal makespan, but the solution space is prohibitively large for exhaustive searches. To find the optimal (or near-optimal) combination of these three variables in the solution space, an optimization heuristic can be provided to generate the solution in an efficient manner using a genetic method. By representing the three variables in a “chromosome” and allowing them to compete and evolve, the method converges towards an optimal (or near-optimal) solution.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

### REFERENCES

[Adamic02] L. Adamic. “Zipf, Power-laws, and Pareto—a ranking tutorial.” www.hpl.hp.com/research/idl/papers/ranking/ranking.html
[Baeck+00] T. Baeck, D. Fogel, and Z. Michalewicz (eds). Evolutionary Computation 1: Basic Methods and Operators. Institute of Physics Publishing, 2000.
[Braun+01] T. Braun, H. Siegel, N. Beck, L. Boloni, M. Maheswaran, A. Reuther, J. Robertson, M. Theys, B. Yao, D. Hengsen, and R. Freund. “A Comparison of Eleven Static Heuristics for Mapping a Class of Independent Tasks onto Heterogeneous Distributed Computing Systems,” Journal of Parallel and Distributed Computing, vol. 61, no. 6, June 2001.
[Casanova+00] H. Casanova, A. Legrand, D. Zagorodnov, F. Berman. “Heuristics for Scheduling Parameter Sweep Applications in Grid Environments,” In Proceedings of the 9^{th} Heterogeneous Computing Workshop, May 2000.
[Chakrabarti+04] A. Chakrabarti, D. R. A., and S. Sengupta. “Integration of Scheduling and Replication in Data Grids,” In Proceedings of the International Conference on High Performance Computing, 2004.
[Davis85] L. Davis. “Job Shop Scheduling with Genetic Methods,” In Proceedings of the International Conference on Genetic Methods, 1985.
[Deelman+04] E. Deelman, T. Kosar, C. Kesselman, and M. Livny. “What Makes Workflows Work in an Opportunistic Environment?” Concurrency and Computation: Practice and Experience, 2004.
[Feitelson94] D. Feitelson. “A Survey of Scheduling in Multiprogrammed Parallel Systems,” IBM Research Report RC 19790 (87657), 1994.
[Feitelson+04] D. Feitelson, L. Rudolph, and U. Schwiegelshohn. “Parallel Job Scheduling—A Status Report,” In Proceedings of the 10^{th} Workshop on Job Scheduling Strategies for Parallel Processing, 2004.
[Griphyn] The Grid Physics Network. www.griphyn.org
[Holtman+01] K. Holtman. “CMS Requirements for the Grid,” In Proceedings of the International Conference on Computing in High Energy and Nuclear Physics, 2001.
[Hu+04] N. Hu, L. Li, Z. Mao, P. Steenkiste, and J. Wang. “Locating Internet Bottlenecks: Methods, Measurements, and Implications,” In Proceedings of SIGCOMM 2004.
[Kosar+04] T. Kosar and M. Livny. “Stork: Making Data Placement a First Class Citizen in the Grid,” In Proceedings of IEEE International Conference on Distributed Computing Systems, 2004.
[Litka95] D. Lifka. “The ANL/IBM SP Scheduling System,” In Job Scheduling Strategies for Parallel Processing, Lecture Notes on Compute Science, Springer-Verlag 1995.
[Michalewicz+00] Z. Michalewicz and D. Fogel. How to Solve It: Modern Heuristics, Springer-Verlag, 2000.
[Mohamed+04] H. Mohamed and D. Epema. “An Evaluation of the Close-to-Files Processor and Data Co-Allocation Policy in Multiclusters,” In Proceedings of the IEEE International Conference on Cluster Computing, 2004.
[Mu'alem+01] A. Mu'alem and D. Feitelson. “Utilization, Predictability, Workloads,and User Runtime Estimates in Scheduling the IBM SP2 with Backfilling,” IEEE Transactions on Parallel and Distributed Systems, June 2001.
[PPDG] The Particle Physics Data Grid. www.ppdg.net
[Ranganathan+03] Kavitha Ranganathan and Ian Foster. “Computation Scheduling and Data Replication Methods for Data Grids,” Grid Resource Management: State of the Art and Future Trends, J. Nabrzyski, J. Schopf, and J. Weglarz, eds. Kluwer Academic Publishers, 2003.
[Ribeiro+04] V. Ribeiro, R. Riedi, and R. Baraniuk. “Locating Available Bandwidth Bottlenecks,” IEEE Internet Computing, September-October 2004.
[Santos-Neto+04] E. Santos-Neto, W. Cirne, F. Brasileiro, and A. Lima. “Exploiting Replication and Data Reuse to Efficiently Schedule Data-Intensive Applications on Grids,” In Proceedings of the 10^{th} Workshop on Job Scheduling Strategies for Parallel Processing, 2004.
[Schmueli+03] E. Schmueli and D. Feitelson. “Backfilling with Lookahead to Optimize the Packing of Parallel Jobs,” Springer-Verlag Lecture Notes in Computer Science, vol. 2862, 2003.
[Stockinger+01] H. Stockinger, A. Samar, B. Allcock, I. Foster, K. Holtman, and B. Tierney. “File and Object Replication in Data Grids,” In Proceedings of the 10^{th} International Symposium on High Performance Distributed Computing, 2001.
[Thain+01] D. Thain, J. Bent, A. Arpaci-Dusseau, R. Arpaci-Dusseau, and M. Livny. “Gathering at the Well: Creating Communities for Grid I/O”, In Proceedings of Supercomputing, 2001.

What is claimed is:

1. A method, comprising:
co-scheduling an assignment of jobs and a replication of data objects based on job ordering within a scheduler queue, job-to-compute node assignments, and object-to-local data store assignments;
assigning said jobs to compute nodes based on results of said co-scheduling; and
simultaneously replicating said data objects to local data stores based said results of said co-scheduling.

2. The method according to claim 1, further comprising determining said job ordering according to an order in which said jobs are assigned from said scheduler to said compute nodes.

3. The method according to claim 1, further comprising determining said job-to-compute node assignments according to which of said jobs are assigned to which of said compute nodes.

4. The method according to claim 1, further comprising determining said object-to-local data store assignments according to which of said data objects are replicated to which of said local data stores.

5. The method according to claim 1, wherein said co-scheduling comprises:
creating chromosomes comprising first strings, second strings, and third strings,
such that said first strings comprise possible arrays of said job ordering,
such that said second strings comprise possible arrays of said job-to-compute node assignments, and
such that said third strings comprise possible arrays of said object-to-local data store assignments.

6. The method according to claim 5, wherein said co-scheduling further comprises:
at least one of recombining and mutating said first strings, said second strings, and said third strings to create new arrays of said job ordering, said job-to-compute node assignments, and said object-to-local data store assignments.

7. The method according to claim 6, wherein said co-scheduling further comprises determining an execution time of at least one of said new arrays.

8. A method, comprising:
co-scheduling an assignment of jobs and a replication of data objects based on job ordering within a scheduler queue, job-to-compute node assignments, and object-to-local data store assignments, wherein said co-scheduling comprises:
creating chromosomes comprising first strings, second strings, and third strings,
such that said first strings comprise possible arrays of said job ordering,
such that said second strings comprise possible arrays of said job-to-compute node assignments, and
such that said third strings comprise possible arrays of said object-to-local data store assignments;
assigning said jobs to compute nodes based on results of said co-scheduling; and
simultaneously replicating said data objects to local data stores based said results of said co-scheduling.

9. The method according to claim 8, further comprising:
determining said job ordering according to an order in which said jobs are assigned from said scheduler to said compute nodes;
determining said job-to-compute node assignments according to which of said jobs are assigned to which of said compute nodes; and
determining said object-to-local data store assignments according to which of said data objects are replicated to which of said local data stores.

10. The method according to claim 8, wherein said co-scheduling further comprises:
at least one of recombining and mutating said first strings, said second strings, and said third strings to create new arrays of said job ordering, said job-to-compute node assignments, and said object-to-local data store assignments; and
determining an execution time of at least one of said new arrays.

11. A service, comprising:
co-scheduling an assignment of jobs and a replication of data objects based on job ordering within a scheduler queue, job-to-compute node assignments, and object-to-local data store assignments;
assigning said jobs to compute nodes based on results of said co-scheduling; and
simultaneously replicating said data objects to local data stores based said results of said co-scheduling.

12. The service according to claim 11, further comprising:
determining said job ordering according to an order in which said jobs are assigned from said scheduler to said compute nodes;
determining said job-to-compute node assignments according to which of said jobs are assigned to which of said compute nodes; and
determining said object-to-local data store assignments according to which of said data objects are replicated to which of said local data stores.

13. The service according to claim 11, wherein said co-scheduling comprises:
creating chromosomes comprising first strings, second strings, and third strings,
such that said first strings comprise possible arrays of said job ordering,
such that said second strings comprise possible arrays of said job-to-compute node assignments, and
such that said third strings comprise possible arrays of said object-to-local data store assignments.

14. The service according to claim 13, wherein said co-scheduling further comprises:
at least one of recombining and mutating said first strings, said second strings, and said third strings to create new arrays of said job ordering, said job-to-compute node assignments, and said object-to-local data store assignments.

15. The service according to claim 14, wherein said co-scheduling further comprises determining an execution time of at least one of said new arrays.

16. A computer program product comprising a computer usable medium tangibly embodying a computer readable program, wherein the computer readable program, when executed on a computer, causes the computer to perform a method comprising:
co-scheduling an assignment of jobs and a replication of data objects based on job ordering within a scheduler queue, job-to-compute node assignments, and object-to-local data store assignments;
assigning said jobs to compute nodes based on results of said co-scheduling; and
simultaneously replicating said data objects to local data stores based said results of said co-scheduling.

17. The computer program product according to claim 16, wherein said method further comprises:
determining said job ordering according to an order in which said jobs are assigned from said scheduler to said compute nodes;
determining said job-to-compute node assignments according to which of said jobs are assigned to which of said compute nodes; and
determining said object-to-local data store assignments according to which of said data objects are replicated to which of said local data stores.

18. The computer program product according to claim 16, wherein said co-scheduling comprises:
creating chromosomes comprising first strings, second strings, and third strings,
such that said first strings comprise possible arrays of said job ordering,
such that said second strings comprise possible arrays of said job-to-compute node assignments, and
such that said third strings comprise possible arrays of said object-to-local data store assignments.

19. The computer program product according to claim 18, wherein said co-scheduling further comprises:
at least one of recombining and mutating said first strings, said second strings, and said third strings to create new arrays of said job ordering, said job-to-compute node assignments, and said object-to-local data store assignments.

20. The computer program product according to claim 19, wherein said co-scheduling further comprises determining an execution time of at least one of said new arrays.
